(19) United States
(12) Patent Application Publication
(10) Pub. No.: US 2023/0169416 A1
(43) Pub. Date: Jun. 1, 2023

(54) PEST DISTRIBUTION MODELING WITH HYBRID MECHANISTIC AND MACHINE LEARNING MODELS

(71) Applicant: X Development LLC, Mountain View, CA (US)

(72) Inventors: Michal Kazmierski, Poznan (PL); Haoyu Zhang, San Marino, CA (US); Szymon Zmyslony, Risch (CH)

(21) Appl. No.: 17/894,850

(22) Filed: Aug. 24, 2022

Related U.S. Application Data
(60) Provisional application No. 63/284,845, filed on Dec. 1, 2021.

(51) Int. Cl. G06Q 10/06; G06Q 50/02; G06Q 10/04

(52) U.S. Cl. CPC G06Q 10/063; G06Q 10/04; G06Q 50/02

(57) ABSTRACT

Systems and methods for modeling a population density of a pest are provided. A computer implemented method for modeling a population density of a pest can include receiving environmental data corresponding to a first time point. The method can include generating model input data from the environmental data using a machine learning model. The method can also include generating a population density of the pest from the model input data using a mechanistic model. The population density can correspond to a second time point temporally after the first time point.

### CROSS-REFERENCE TO RELATED APPLICATIONS

This application claims the benefit of U.S. Application No. 63/284,845, filed on Dec. 1, 2021, the contents of which are incorporated herein by reference.

### TECHNICAL FIELD

This disclosure relates generally to sensor systems, and in particular but not exclusively, relates to systems and techniques for monitoring and modeling pest populations.

### BACKGROUND INFORMATION

Many important agricultural pests are insects. The study of biological life cycles, such as the developmental cycles of insects, is known as phenology, and many phenological models exist for different pest insect species. The overall goal of pest modeling is to predict aspects of insect population dynamics within a season to inform management decisions, such as the timing of pesticide applications or other interventions. Accurate prediction is crucial for pest management, can help reduce pesticide use, and can reduce crop damage by enabling more precise application.

Typical models were developed in laboratory conditions. While simple and easy to implement, such models incorporate simplifying assumptions to reduce the number of parameters and cross-coupling of environmental factors. Pest population dynamics can be influenced significantly by environmental factors that are ignored by typical models. Simplifications, such as reducing the number of input variables, introduce error and significantly limit the flexibility of the models to account for in situ environmental conditions.

Accurate pest intervention prediction and timing remain a labor intensive and challenging process. For example, empirical models can be calibrated using field measurements including multiple pest trap measurements over a period of time and for multiple different locations. Without in situ population measurements, it is difficult to identify whether an empirical model is accurately predicting pest population events, such as first emergence, peak population, or generation timings. Furthermore, only a limited set of models are available for each pest/host combination, and empirical models cannot be adapted for events that are not simulated in laboratory conditions. As such, there remains a need for improved pest population modelling techniques that account for complex environmental factors describing the in situ conditions of a growth environment for which ground truth data is sparse.

### BRIEF DESCRIPTION OF THE DRAWINGS

Non-limiting and non-exhaustive embodiments of the invention are described with reference to the following figures, wherein like reference numerals refer to like parts throughout the various views unless otherwise specified. Not all instances of an element are necessarily labeled so as not to clutter the drawings where appropriate. The drawings are not necessarily to scale, emphasis instead being placed upon illustrating the principles being described.

FIG. 1 is a schematic diagram illustrating components of an example system for modelling population dynamics of a pest, in accordance with embodiments of the disclosure.

FIG. 2 is a process flow diagram illustrating an example process for modeling population dynamics of a pest, in accordance with embodiments of the disclosure.

FIG. 3 is a data flow diagram illustrating an example hybrid model for predicting pest population dynamics, in accordance with embodiments of the disclosure.

FIG. 4 is a schematic diagram illustrating example environmental data, in accordance with embodiments the disclosure.

FIG. 5A is an example population graph illustrating example data generated by a hybrid model trained to predict and/or model population density distribution as a function of time, in accordance with embodiments of the disclosure.

FIG. 5B is an example cumulative population graph illustrating example data generated by a hybrid model trained to predict and/or model cumulative population density as a function of time, in accordance with embodiments of the disclosure.

FIG. 5C is an example contour graph illustrating example data generated by a hybrid model trained to predict and/or model population density distributions as a function of time and space, in accordance with embodiments of the disclosure.

FIG. 6 is a block flow diagram illustrating an example method for modelling population dynamics of a pest, in accordance with embodiments of the disclosure.

In the above-referenced drawings, like reference numerals refer to like parts throughout the various views unless otherwise specified. Not all instances of an element are necessarily labeled to simplify the drawings where appropriate. The drawings are not necessarily to scale, emphasis instead being placed upon illustrating the principles being described.

### DETAILED DESCRIPTION

Embodiments of a system, a method, and computer executable instructions for modelling population dynamics of a pest are described herein. In the following description, numerous specific details are set forth to provide a thorough understanding of the embodiments. One skilled in the relevant art will recognize, however, that the techniques described herein can be practiced without one or more of the specific details, or with other methods, components, materials, etc. In other instances, well-known structures, materials, or operations are not shown or described in detail to avoid obscuring certain aspects.

Reference throughout this specification to “one embodiment” or “an embodiment” means that a particular feature, structure, or characteristic described in connection with the embodiment is included in at least one embodiment of the present invention. Thus, the appearances of the phrases “in one embodiment” or “in an embodiment” in various places throughout this specification are not necessarily all referring to the same embodiment. Furthermore, the particular features, structures, or characteristics can be combined in any suitable manner in one or more embodiments.

Many important agricultural pests are insects. The study of biological life cycles, such as the developmental cycles of insects is known as phenology, and there are many existing phenological models for various pest insect species. The overall goal of pest modeling is to predict various aspects of insect population dynamics within a season in inform management decisions, such as the timing of pesticide applications or other interventions. Accurately predicting insect population dynamics of insects is crucial for pest management and can help reduce pesticide use while also minimizing the damage to crops by enabling more precise application.

Since most insects cannot reliably maintain constant body temperature, insect life cycle and population dynamics are strongly dependent on environmental conditions, such as ambient temperature. Typically, each species has a lower developmental temperature threshold below which no development occurs. In controlled lab environments, the rate of development is typically directly proportional to the excess temperature above the lower threshold. A widely used method of quantifying the relationship between temperature and insect biology makes use of a parameter referred to as growing degree days (GDDs). GDDs describe a measure of time and temperature for which the ambient temperature exceeds the lower developmental temperature threshold.

GDD-based heuristic models are developed for individual pest/host combinations by controlled experiment in laboratory conditions. For example, empirical models can determine that a first emergence of the first generation of a pest occurs on average at 100 GDD following a reference date. Another commonly given estimate is generation time, which is the number of accumulated GDDs between generation peaks. For example, a multi-generational experiment in laboratory conditions can determine that the generation timing is 500 GDD. In this way, where the peak of a first generation is observed at 300 GDD since January 1st, a second generation would be predicted to peak at 800 GDD.

Models based on GDD estimates rely on heuristics developed in laboratory conditions that, while simple and easy to implement, incorporate simplifying assumptions to reduce the number of parameters and cross-coupling of environmental factors. Such simplifications introduce error and significantly limit the flexibility of the GDD models to adapt to in situ growing conditions. For at least this reason, pest intervention prediction and timing remain a labor intensive and challenging process.

For example, GDD models can be calibrated using field measurements, requiring multiple pest trap measurements over multiple days. Without in situ population measurements, it is impossible to identify whether an empirical model is accurately predicting pest population events, such as first emergence, peak population, or generation timing. Furthermore, only a limited set of models are available for each pest/host combination, and empirical models cannot be adapted for events that are not simulated in laboratory conditions. As such, there remains a need for improved pest population modelling techniques that account for complex environmental factors directly describing the in situ conditions of a growth environment, where ground truth data is sparse.

In an illustrative example, many insect pests have distinct generations within one season, referred to as multivoltinism. Different generations manifest as distinct population peaks in observations from a particular season or year. Knowledge about the emergence of each generation is important when managing many pests, as the generations can have distinct biology and interactions with crops. In the context of almond cultivation, the first generation of navel orangeworm typically lays eggs on old fruits left over from the previous year and does not directly damage future harvests. Subsequent generations in the same orchard, however, tend to be synchronized with the development of new fruit and cause significant crop damage. In this example, interventions can differ between pest generations. For example, the first generation can be treated to trap adult insects (e.g., using pheromone traps), while a second generation can be treated to reduce egg or larval numbers (e.g., by spraying), before the pest is established or proliferates in an orchard. For example, interventions can include targeted chemical interventions, such as mating disruption, that do not kill insects directly, but rather prevent/reduce reproduction as an approach to limit the proliferation of the targeted pest.

Simple GDD models do not differentiate between generations and cannot provide contextual intervention predictions. Similarly, typical models do not account for environmental factors that can affect the activity of an insect pest. For example, flying insects are affected by precipitation, and some are affected by smoke. To that end, population measurements that ignore the distinction between population and activity risk misinterpretation of insect trap data, which introduces error into model predictions.

In reference to the forthcoming paragraphs, description of embodiments focuses on navel orangeworm (Amyelois transitella, a type of moth) infestation of almond orchards as an example pest/host combination, but alternative applications are contemplated where hybrid machine learning (ML) - mechanistic models can be trained to predict pest population dynamics and event/intervention timings. In general, the techniques described can be applied to pest/host systems for which some ground-truth data is available, for example, through regular albeit infrequent visits by human inspectors, that can be supplemented with rich environmental datasets including historical data, current data, and/or predicted data.

Examples of alternative pest/host systems can include, but are not limited to, flying insects (e.g. Lepidoptera, Cynipidae, Diptera) and/or non-flying insects (e.g. Aphidae, Lygus). In some embodiments, non-animal pests can also be modeled in addition to or in place of insect pests. For example, non-insect pests include but are not limited to weeds (e.g., invasive, parasitic, competitor, or otherwise undesirable plants) and plant diseases (e.g., fungal, bacterial, protozoan, viral, etc.). In some embodiments, different models apply to different pest types, corresponding to characteristic growth and proliferation dynamics. As such, the techniques described herein (e.g., ML models and mechanistic models), can be adapted to a given pest/host system. In situ environmental conditions and the complex interactions between the measured and/or predicted environmental parameters can be accounted for through learned models, trained on sparse labeled data to predict inputs to empirical and/or mechanistic models. In this way, environmental data can be leveraged to predict inputs for mechanistic models that output population metrics such as population density, cumulative emergence, and/or event timings for specific pest/host combinations. In light of the simplifying assumptions used to prepare mechanistic models, ML models can be used to reintroduce nuanced interactions between environmental conditions, beyond the simple univariate approaches used for developing the mechanistic models. For example, supervised learning techniques can be used to train deep networks on ground truth data, even where ground truth data is scarce due to the labor and expertise involved in data collection from pest traps that are placed and monitored in situ.

Once trained, ML models can be incorporated into hybrid models implemented as cloud-based applications and/or mobile applications to monitor pest population dynamics. Hybrid model outputs can include but are not limited to: population density over time, representing the instantaneous rate of population growth; cumulative density, representing the proportion of the total population emerged up to a time, “t;” and/or the timings of various events of relevance to pest management, such as the time of first emergent of a pest or an estimated time of peak population. In some embodiments, wireless bandwidth and battery power can be conserved by optimizing the ML models to run on user devices, such as smart phones, and only transmitting summary analysis, as opposed to the raw data, to the cloud-based application.

Data describing the environment of a host cultivation area can be collected and combined with ground truth data from a grower using a mobile application installed on a mobile computing device. Alternatively or additionally, data can be sent to a cloud-based application that can be accessed remotely. The data provides the grower with real-time state of the pest population and dynamic predictions for pest population events and recommended intervention timings. These and other features of the modelling system are described below.

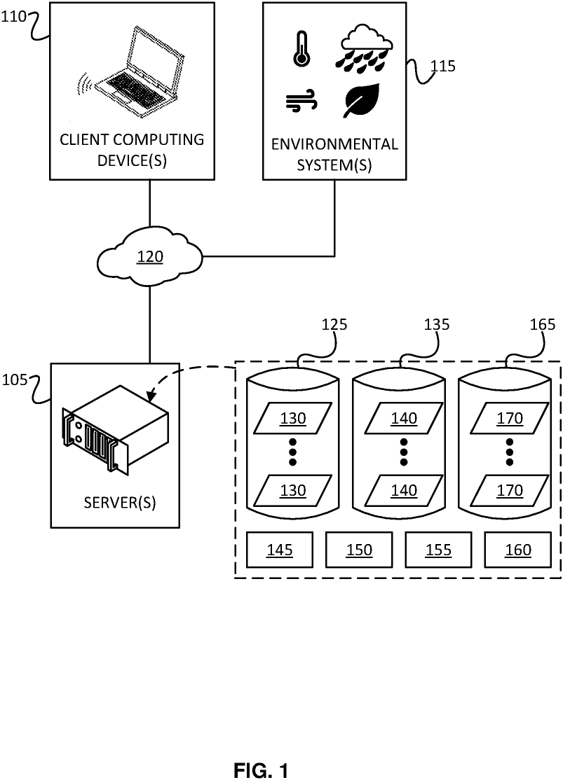

FIG. 1 is a schematic diagram illustrating components of an example system for modelling population dynamics of a pest, in accordance with embodiments of the disclosure. Example system 100 includes: one or more servers 105, one or more client computing devices 110, one or more sources of environmental data 115, and a network 120. The server(s) 105 include: a first database 125 of training data 130, a second database 135 of population density data 140, one or more machine learning models 145 and one or more mechanistic models 150 encoded in software 155. As part of software 155, server(s) 105 include instructions by which the models 145-150 are trained and/or deployed using computer circuitry 160. In some embodiments, server(s) 105 further include a third database 165 storing ground truth data 170 that describes pest populations collected in situ, for example, by trap sampling.

The following description focuses on embodiments implementing a networked system for training and/or deploying machine learning models 145 as part of a system for generating population density, cumulative density, emergence timing, and/or intervention timing predictions for a given pest/host combination. It is contemplated, however, that some embodiments of the present disclosure include some or all of the processes being implemented on client computing device(s) 110, such as a laptop, smartphone, or personal computer. For example, the training of ML models 145 can be implemented using server(s) 105, while trained ML models 145 can be transferred to client computing device 110 via network 120 and can be deployed directly on client computing device 110. Similarly, the constituent elements of example system 100 can be hosted and/or stored on a distributed computing system (e.g., a cloud system) rather than in a unitary system. For example, first database 125, second database 135, third database 165, and/or computer circuitry 160 can be implemented across a distributed system, such that portions of training data 130, population density data 140, software 155, and/or ground truth data 170 can be stored or executed by a distributed computing system in one or more physical locations.

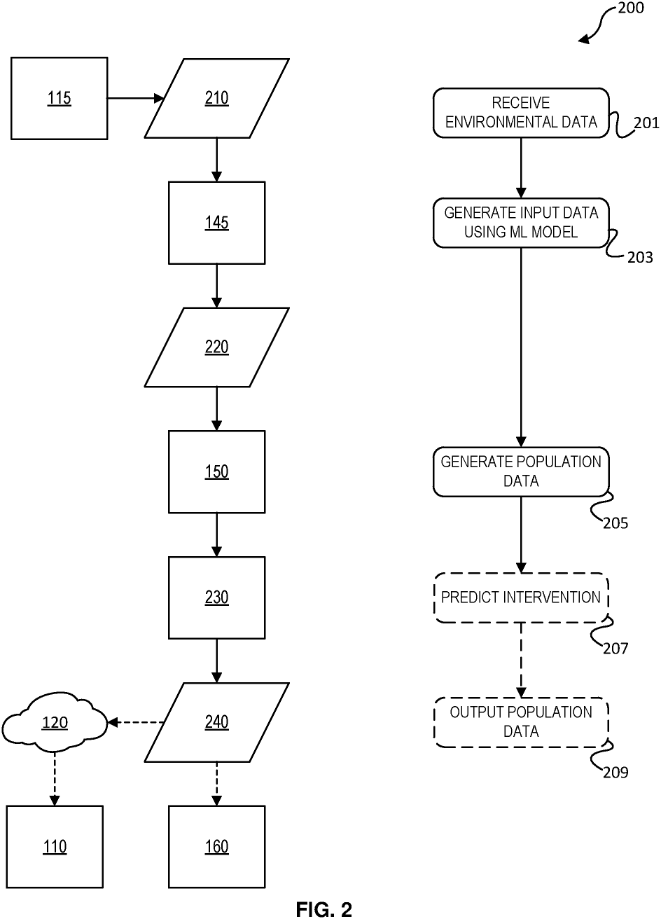

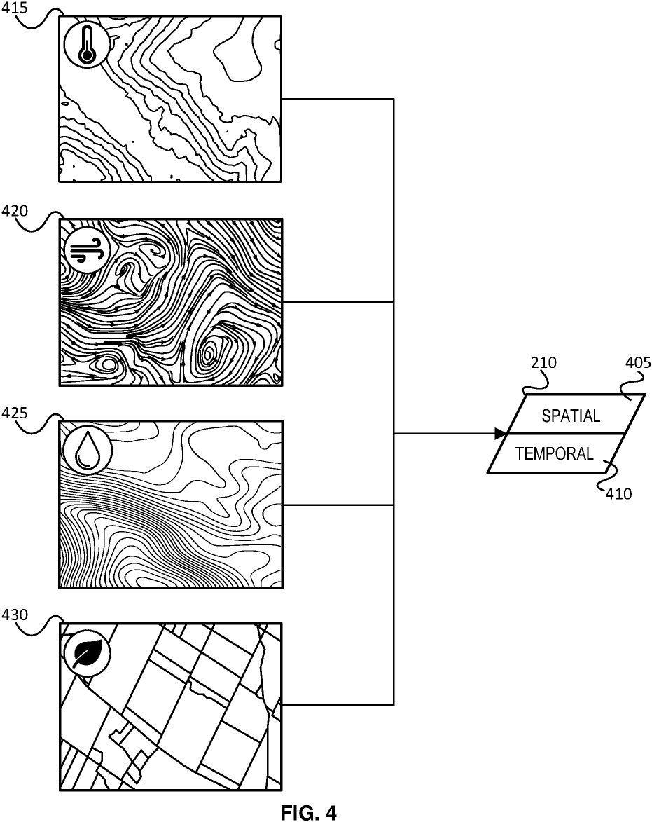

In an illustrative example of the operation of example system 100, server(s) 105 and/or client computing device(s) 110 receive environmental data 210 (in reference to FIG. 2) describing conditions and physical characteristics of a host environment that are measured and/or predicted by sources 115. Environmental data 210 can be or include meteorological data, hyperspectral data, topographic data, segmented and/or classified image data, or the like, as described in more detail in reference to FIG. 4. Environmental data 210 can be accessed, received, and/or stored locally on client computing device 110. Additionally or alternatively, environmental data 210 can be accessed, received, and/or stored to server(s) 105 via network 120. Hybrid models include ML models 145 and mechanistic models 150 that are trained/prepared to input environmental data 210 and output predicted population data, which can be pushed to user devices, such as client computing device 110. In some embodiments, example system 100 is configured to implement automated procedures, such as scheduling interventions, implementing interventions, generating notifications to be presented to users of client computing devices 110.

In the context of example system 100, sources of environmental data 115 are represented by a collection of visual symbols (e.g., a thermometer), to simplify visual explanation. Sources of environmental data 115 include, but are not limited to, in situ sensors, orbital imaging/spectroscopy platforms, meteorological models or data collection systems, and/or user-labeled data. As an illustrative example, sources of environmental data 115 can include in situ sensors for ambient temperature, humidity, carbon dioxide, chemical pollution, GPS location, wind speed, atmospheric pressure, or the like (e.g., as in a meteorological sensor station). In some embodiments, sources of environmental data 115 also include meteorological predictions for a location of the host vegetation generated by a weather model. Environmental data can be localized to a physical area by correlating physical locations of sensors (e.g., GPS data) with extent information describing the physical space where host vegetation is grown (e.g., the metes and bounds of an almond orchard within a polyculture agricultural region). Extent information can be generated by manual labeling of map data and/or satellite images (e.g., hyperspectral images indicating spatial variation in water content), automated (e.g., without human intervention) classification/segmentation of satellite images, or through communication of planting data with agricultural systems, such as planting systems that include internet-connected systems. In an example, a planter can include a GPS sensor and an internet connected computer system that can generate planting data describing locations and seed identifier information for planting operations. In turn, the planting data can be shared with example system 100 as part of environmental data 210.

In some embodiments, updated ground truth data 170 and/or new ground truth data 170 are received from sources 115, for example, where an untrained ML model 145 is to be trained for a new pest/host system or a new location, for which an ML model 145 is not yet available. In this way, it is contemplated that example system 100 will support retraining of ML models 145 and preparing new hybrid models 145-150 with changes to ground truth data 170, shifts in environmental conditions, and competitive adaptation of pest/host systems over time.

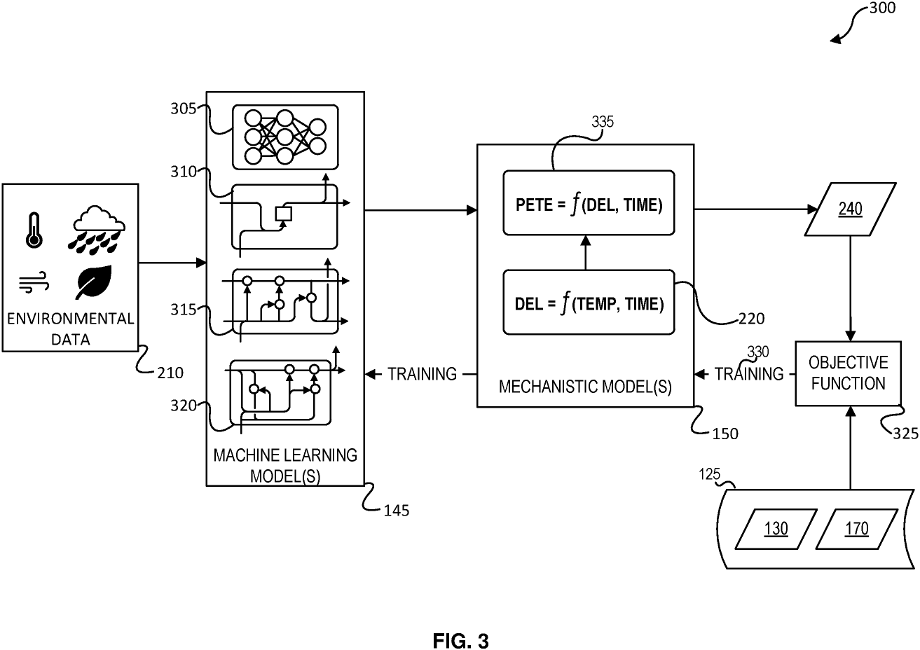

As described in more detail in the forthcoming paragraphs, ML model 145 generates input data 220 for mechanistic model 150 by processing environmental data 210 and generating an intermediate parameter describing kinetic aspects of pest population development, such as a DEL parameter, as described in more detail in reference to FIG. 3. The model input data 220 are used to generate population data 240 using mechanistic model 150, which can be used to generate predicted timings, recommended interventions, and/or population characteristics for the pest/host system. Once generated, environmental data 210, input data 220, and/or population data 240 can be stored as training data 130 and/or can be transferred to other constituent elements of example system 100.

Training of ML model(s) 145 and/or tuning of mechanistic model(s) 150 can include gradient-based optimization of loss functions or other criteria, such as error minimization, such that a hybrid model that includes ML model(s) 145 and mechanistic model(s) 150 can be trained in tandem. Data preparation, training techniques, and model architecture are described in more detail in reference to FIG. 3.

FIG. 2 is a process flow diagram illustrating an example process 200 for modeling population dynamics of a pest, in accordance with embodiments of the disclosure. Example process 200 may be implemented by one or more constituent elements of example system 100 of FIG. 1, including but not limited to server(s) 105 and/or client computing device(s) 110. Example process 200 includes operations 201-209 for receiving environmental data 210, generating input data 220 for mechanistic model(s) 150 using ML model(s) 145, generating population data 240 from input data 220 using mechanistic model(s) 150, predicting intervention timings, and outputting population data 240.

Example process 200 is illustrated as a series of operations 201-209 implemented by a computer system using models encoded in software. For example, the operations of example process 200 can include implementation of models 145 and 150, stored as computer-readable instructions in software 155 that are executed by computing circuitry 160 of server(s) 105. In some embodiments, the operations of example process 200 are divided between multiple systems. For example, at least a subset of the operations of example process 200 can be executed locally on client computing device 110, while a different subset of the operations of example process 200 can be executed on a distributed system of server(s) 105. For example, outputting operations can be executed on client computing device 110 as part of an interactive pest monitoring platform that solicits user feedback and provides notifications of pest population dynamics in advance and/or in near-real time.

In this context, the term “near-real time” is used to refer to a delay in delivering pest population data within a time frame during which an intervention can be effectively staged. For example, an intervention recommendation may be characterized by a timing window on the order of days and a spraying operation may occupy a period of time of hours, such that a delay in receiving pest population data and/or intervention recommendations on the order of minutes or hours does not impair the effectiveness of the prediction. Similarly, where an intervention is time-sensitive on the order of hours, population data that is delayed by hours may still be effective if the data accurately describe future conditions more than one day in advance. Advantageously, the operations 201-209 of example process 200 can be prioritized, parallelized, distributed, or otherwise coordinated to provide population and/or intervention data within a timeframe where it can be effective for the user, being informed, for example, by the temporal sensitivity of the data being generated.

The order in which some or all of the process blocks appear in example process 200 should not be deemed limiting. Rather, one of ordinary skill in the art having the benefit of the present disclosure will understand that some of the operations can be executed in a variety of orders not illustrated, or even in parallel, with some operations omitted or with some optional operations included.

At operation 201, example process 200 includes receiving environmental data 210. Environmental data 210 can be received directly and/or indirectly from sources 115, as part of a pest monitoring platform. For example, an application hosted on client computing device 110 can receive environmental data 210 from sources 115 via network 120. Client computing device 110 can then process environmental data 210 locally to generate input data 220 and/or population data 240. In some embodiments, operation 201 can include communication of environmental data 210 between sources 115 and server(s) 105, where generation of input data 220 and/or population data 240 occurs at least in part on server(s) 105.

In some embodiments, environmental data 210 includes data for a plurality of physical locations as part of a spatiotemporal dataset, as described in more detail in reference to FIG. 4. For example, environmental data 210 can include two-dimensional projection data (e.g., iso-contour maps) for atmospheric pressure, precipitation, wind speed, or the like, that can be developed by meteorological or other models using point-data measured by in situ sensors. As such, environmental data 210 can be received from sources 115 that are in situ (e.g., local sensors) and/or from computer systems that communicate with in situ sensors to generate estimated and/or predicted environmental data 210. Example system 100 can receive environmental data 210 through intermediary systems (e.g., publicly available weather data), rather than communicating directly with a network of sensors specific to the pest/host system. To address limitations in sensor networks and/or prediction systems, in some embodiments, operation 201 includes accessing multiple redundant data sources. Advantageously, accessing redundant environmental data 210 addresses delays in availability of environmental data 210 from any given source and further corrects for error by aggregating environmental data 210.

At operation 203, example process 200 includes generating input data 220 for mechanistic model 150 using ML model 145. ML model(s) 145 are trained to input environmental data 210 and to generate input data 220 for use with mechanistic model(s) 150. As described in more detail in reference to FIG. 3, mechanistic model(s) 150 can include analytical and/or empirical models developed for general or particular pest/host systems. For example, mechanistic model(s) 150 can include the predictive extension timing estimator (PETE) model, which describe pest population dynamics through a system of k coupled equations that are tuned for a specific pest. Input parameters of mechanistic model(s) 150 can be or include time-variant distribution parameters or delay parameters. For example, PETE models include as an input a delay term (“DEL”) that depends on environmental data in a complex way. As such, ML models 145 can be trained to input environmental data 210 and to generate a predicted value for DEL, as described in more detail in reference to FIG. 3. As such, input data 220 does not directly describe pest populations or population dynamics. Instead, ML model(s) 145 generate input data 220 that reintroduces nuanced effects of environmental conditions to mechanistic model(s) 150 developed with simplifying assumptions.

At operation 205, example process 200 includes generating population data from model input data 220 using mechanistic model(s) 150. As described in more detail in reference to FIG. 3, mechanistic model(s) 150 can take in multiple inputs, including but not limited to input data 220 that is generated by ML model(s) 145. In some embodiments, input data 220 corresponds to a timepoint that is temporally after the timepoint described by environmental data 210. In this way, mechanistic model 150 can generate a prediction of population density that can be used to estimate pest population dynamics in advance. For example, environmental data 210 can describe a state of a host environment at a first timepoint, and input data 220 can be used to describe population density, cumulative population density, and emergence information at a second time point, temporally after the first time point. In some embodiments, the first time point and the second time point are separated by a time-step that can be a parameter used in training ML model(s) 145. For example, the time-step can be on the order of minutes, hours, days, or longer, which can be selected to balance the temporal sensitivity of population dynamics and the computational resources available to operate the system.

Population data 220 can also include time-sequence data, for example, where ML model(s) 145 include recurrent neural network (RNN) or other models that are configured to take in an input vector and to generate an output vector. In some embodiments, the input vector of ML model(s) 145 can be or include forecasted data for the geographical location(s) corresponding to the host-environment, such as predicted temperature, wind, precipitation, humidity, or other data. In some embodiments, environmental data forms a sequence where multiple types of environmental data are included in a single input vector. In this way, ML model(s) 145 can be configured and trained to output a sequence of predicted model input data 220 that describes input parameters for mechanistic model(s) 150 as a time sequence vector. In some embodiments, the entries in the time sequence vector are separated by a consistent time step. The time step can be determined from parameters that are standard to the configuration of the mechanistic model 150 or can be configured as part of model design. In an illustrative example, the time step can correspond to ¼ of a day or approximately 6 hours. Examples of sequence model architectures are described in more detail in reference to FIG. 3.

Advantageously, implementing a hybrid-model approach in example process 200 permits improved performance and accuracy of model predictions. For example, by constraining predictions generated by machine learning model(s) 145 using mechanistic model(s) 150, efficiency of training of ML models 145 and accuracy of model predictions can be improved. Additionally, computational resources used to train and tune combined hybrid models can be reduced. For example, constraining ML model(s) 145 to predict input data 220, rather than population data 240, improves the convergence of ML model(s) 145 to a physically meaningful result, in contrast to end-to-end ML techniques. Advantageously, improved accuracy and reduced latency of predicted population data at operation 205 permits improved intervention prediction and recommendation.

To that end, example process 200 can include predicting an intervention window at operation 207. The intervention window generally corresponds to a period of time during which an intervention is recommended to prevent proliferation of the pest in the host environment. Accurate prediction of the intervention window can improve the effectiveness of control efforts against the proliferation of the pest in the environment. In some embodiments, example process 200 includes generating an estimated total emergence of the pest using the population data generated at operation 205. Estimated total emergence of the pest describes the total population of the pest predicted to emerge during a generation from a time corresponding to first emergence of the pest to an end time at which the generation is considered to be complete. It is understood that pest populations are described by statistical distributions, rather than discrete and deterministic populations. In this way, the time of first emergence of the pest and the time at which the generation is considered to be complete may not correspond exactly to the first or last insect to be found in a host environment, especially where the pest exhibits multivoltinism.

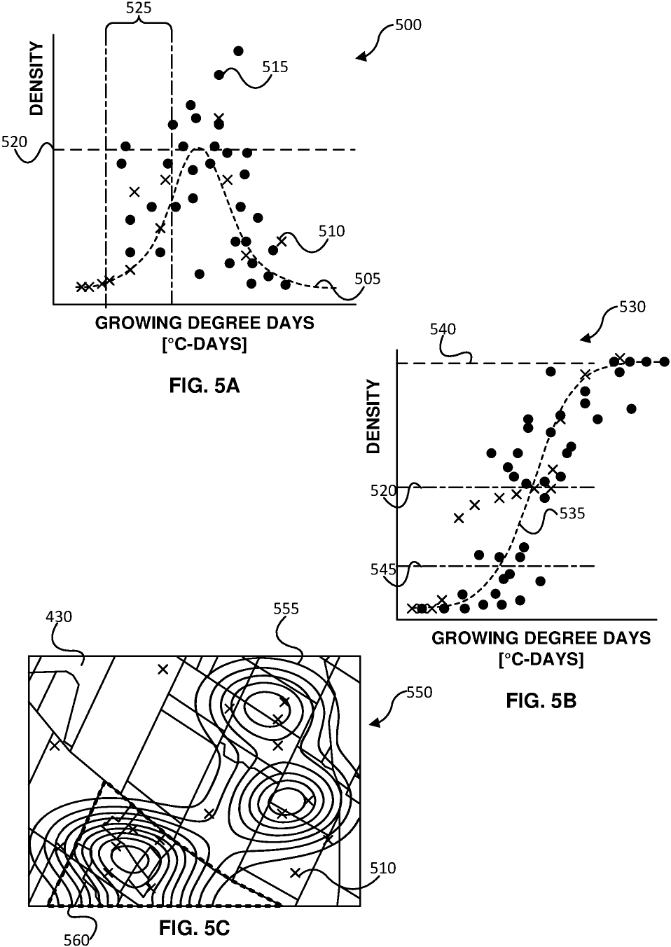

An estimate of the total emergence of the pest permits operation 207 to include generating an estimated cumulative emergence of the pest at the second time point. In this context, the estimated cumulative emergence describes a fraction of the total emergence of the pest at a given time between the time of first emergence and between the time of full emergence. In turn, the estimated cumulative emergence can serve as a comparison value for determining intervention timings. In an illustrative example, operation 207 can include predicting an intervention window by comparing the cumulative emergence at the second time point to a predetermined threshold value describing a percentage of the total emergence at that time point. In situations where the cumulative emergence at the time point exceeds the threshold value, the intervention window can be predicted to include or otherwise overlap the time point corresponding to population data 240 generated at operation 205, as described in more detail in reference to FIG. 5B.

In some embodiments, predicting the intervention window includes generating a predicted time of a predetermined threshold emergence fraction using a logistic sigmoid model 230. As described in more detail in reference to FIG. 5, a logistic sigmoid model 230 can be used to fit a sigmoid curve to the cumulative population density data predicted at operation 205. The output of the sigmoid model 230 can then be used to predict a future time at which the emergence fraction will exceed the threshold emergence fraction, above which an intervention may be ineffective at reducing a proliferation of the pest in the host environment. In some embodiments, the duration of the intervention window can be informed by biological and/or process information for the pest-host system or the intervention. For example, pest population dynamics can be sensitive to the precise timing of the intervention, as when a pest rapidly begins to lay eggs or reproduce after emergence (e.g., as in aphidae). Conversely, an intervention can be effective over a broad period of time, where insects spend a period of time in an egg stage that is relatively long compared to the duration of an intervention (e.g., spraying).

Predicting the intervention window at operation 207, therefore, can include determining a window of time preceding the time predicted using the sigmoid model 230 that permits a particular intervention to be effective. It is understood that a logistic sigmoid model 230 is an example of a fitting function that can be used to describe the temporal development of cumulative population density data. In some embodiments, other models can be used that account for additional and/or alternative aspects of insect population development. For example, tuning parameters, adjustment factors, piece-wise functions, convoluted gaussian or other distribution functions, or the like, can be used with or instead of sigmoid model 130 to fit a logistic curve to cumulative population data.

In some embodiments, example process 200 includes outputting population data 240 at operation 209. Outputting operations can include electronic communication of population data 240 within a computer system, such as server(s) 105 and/or client computing device(s) 110 or between different systems, as in distributed networked systems and/or between server(s) 105 and client computing device(s) 110. In some embodiments, outputting operations include storing population data 240 and/or intervention data in a data store, such as a memory device of server(s) 105 and/or client computing device(s) 110.

Similarly, outputting operations can include generating visualization and/or notification data and communicating the data to a user device or other associated device, such as a smartphone or an internet connected piece of agricultural equipment. Agricultural equipment can incorporate many of the same types of electronic devices as client computing device 110 or smart phones. As such, operation 209 can include communicating with agricultural equipment, for example, over network 120, such that notifications and/or visualizations can be presented to a user of the agricultural equipment through display devices, acoustic speakers, or the like, that are incorporated into the equipment. In the example of a smartphone, the visualization and/or notification data can be formatted using standardized communication protocols, such that outputting can include sending a digital message including population data 240, intervention timing data, or other types of notifications, without a specialized application.

FIG. 3 is a data flow diagram illustrating an example hybrid model 300 for predicting pest population dynamics, in accordance with embodiments of the disclosure. Example hybrid model 300 may be implemented by one or more constituent elements of example system 100 of FIG. 1, including but not limited to server(s) 105 and/or client computing device(s) 110. For example, example hybrid model 300 may be or include one or more algorithms encoded in software 155. Example hybrid model 300 includes one or more machine learning models 145, one or more mechanistic models 150, and a training system including an objective function 325.

As described in more detail in reference to FIG. 2, example hybrid model 300 includes ML model(s) 145 to generate input data for mechanistic model(s) 150, from which population data 240 is generated. Population data 240, in turn, is compared to training data 130 to generate a training signal 330. As described in more detail in the forthcoming passages, mechanistic model(s) 150 can be or include continuous and differentiable functions of input data 220. As such, gradient-based techniques used for training ML model(s) 145 can be applied by back-propagating training signal 330 through mechanistic model(s) 150 to ML model(s) 145. In some embodiments, data pre-processing operations included as part of training include identifying pest generations by inference of generation boundaries using a gaussian mixture model. Advantageously, clustering techniques applied to data improve evaluation of model performance during training.

Selection of ML model(s) 145 is informed by the type(s) of mechanistic model(s) 150 employed to generate population data 240, which can depend on details of the pest/host system. As an illustrative example, for insect pests, mechanistic model(s) 150 can include a Predictive Extension Timing Estimator (PETE) model 335. Other mechanistic models 150 for insect-pests include, but are not limited to, the Ricker model, the Lotka-Volterra model, and the spruce budworm model. Advantageously, mechanistic models 150 can be selected to account for particular pest population dynamics, which can be specific to a genus, species, or pest/host system. For example, the Lotka-Volterra model includes predator-prey interaction terms, and the spruce budworm model includes terms to account for outbreak dynamics. In this context, the term “outbreak dynamics” refers to a mechanism of pest proliferation that is infrequent and significant in extent. For example, an outbreak of spruce budworm in the Canadian province of Quebec in 2006 resulted in defoliation of approximately 3,000 hectares of forest after several decades of inactivity by the pest.

In some embodiments, models described herein can be augmented to include predation dynamics, pest-disease dynamics, or the like. For example, a predation rate can be expressed as:

$$h \left(w\right) = \frac{{w}^{2}}{1 + {w}^{2}}$$

where “h(w)” represents the predation rate as a direct modifier of the population growth rate that is dependent on the population “w,” a function of time and environmental factors. In this way, one or more different mechanistic models 150, or a combination of terms to account for specific pest/host dynamics, can be selected for use in example hybrid model 300.

PETE model 335 implements a simplifying assumption that insect population development rate is determined primarily by ambient temperature. In particular, PETE model 335 assumes that the rate of development is directly proportional to the temperature in excess of some species-specific lower developmental threshold (just like degree days) and that the dynamics of emergence are governed by a delay differential equation (DDE). The PETE DDE takes the form of a system of k equations:

$$\frac{d {r}_{1}}{d t} = \frac{k}{D E L \left(t\right)} \left(I \left(t\right) - {r}_{1} \left(t\right) \left(1 + \frac{1}{k} \frac{d D E L \left(t\right)}{d t}\right)\right)$$

$$\begin{matrix}\frac{d {r}_{2}}{d t} = \frac{k}{D E L \left(t\right)} \left({r}_{1} \left(t\right) - {r}_{2} \left(t\right) \left(1 + \frac{1}{k} \frac{d D E L \left(t\right)}{d t}\right)\right) \\ ⋮\end{matrix}$$

$$\frac{d y}{d t} = \frac{k}{D E L \left(t\right)} \left({r}_{k - 1} \left(t\right) - y \left(t\right) \left(1 + \frac{1}{k} \frac{d D E L \left(t\right)}{d t}\right)\right)$$

where I(t) represents the input population at time “t,” y represents the predicted emergence at a later time temporally after t, DEL represents a delay parameter that is the reciprocal of the rate of development, rᵢ represents intermediate rates, and k represents the number of equations in the system.

In an illustrative example, the PETE can be applied to model population dynamics of an individual life stage of an insect, for example the emergence of an adult insect from the pupal stage. In this context, the term “emergence” describes a change in population density of the adult insect over time. Since adult insects develop from pupae, “emergence” indicates a positive rate of change of the population density. In some embodiments, it is assumed that the total population of insects is conserved, such that the sum of the number of pupae and the number of adult insects remains constant over time. In some embodiments, additional dynamics are introduced into mechanistic model(s) 150 to account for parasitism, natural death of pupae and/or adult insects, and other factors. Such dynamics can include, but are not limited to, additional terms added to population equations to reduce the population of insects in either life stage.

For PETE model 335, the total emergence of insects is equal to the total number of input insects. In this way, solving the above system for y and dividing by the input population will return a population density that integrates to 1. Cumulative density at time “t” can then be obtained through integration of the instantaneous density between a starting time and “t.” Event predictions can be derived from the instantaneous density and the cumulative density by finding the time at which a respective threshold is met and/or exceeded. In PETE model 335, the number of insects in the pupal stage serves as the initial population I(t). Insects emerge into the adult life stage after spending time in the pupal stage, the duration of which depends on the ambient temperature. Emergence as adult insects occurs after a time delay, reflected as a change in the adult population y(t).

It is assumed that the pupation stage can be described by “k” latent ‘micro-states’ that each insect must pass through before emergence, where “k” is an integer. The “r” variables in the above equations represent the population in each of the k latent micro-states as a function of time. It should be noted that the latent ‘micro-states’ do not correspond to instars or other physiological stages of insect development. Instead, each system of k equations describes a single life stage or generation (e.g. a model with k=6 does not represent six generations) that is accurately described by the simplifying assumptions of PETE model 335. In the context of example hybrid model 300, latent micro-state emergence parameter rᵢ can be considered as a latent variable internal to the mechanistic model(s) 150.

As DEL(t) is a term in each of the k rate equations, the rate of emergence of the adult stage depends on the rate of growth and on the number of intermediate stages. Timing of emergence and the shape of a population emergence curve are accurately described by an Erlang distribution with shape parameter k and time-dependent mean and variance:

$${μ}_{τ} \left(t\right) = D E L \left(t\right)$$

$${σ}_{τ}^{2} \left(t\right) = \frac{{μ}_{τ} {\left(t\right)}^{2}}{k}$$

Where µτ(t) represents the mean value of the Erlang distribution for population density and στ(t) represents the variance of the Erlang distribution. As such, DEL determines the location and width of the emergence curve and k its shape. In an illustrative example, k=1 produces an exponential distribution where population is proportional to e^{t}, while for larger values of k the population density distribution approaches a Gaussian distribution.

Ambient temperature information is incorporated into PETE model 335 through the DEL term, defined as:

$$D E L \left(t\right) = \frac{T D D}{max \left(0 , \left(T \left(t\right) - {T}_{0}\right)\right)}$$

where TDD represents the mean number of accumulated degree-days to go through the stage of growth, T(t) is the temperature and T₀ is the lower temperature threshold for growth. It is apparent that DEL(t) is undefined in circumstances where T(t) is below T₀. It is important to note that DEL is defined as the reciprocal of the rate of growth, defined as proportional to the temperature above the lower threshold temperature. In this way, where ambient temperature is less than the lower threshold temperature, the rate of growth is zero.

In some embodiments, an intervention strategy for an insect pest can include predicting a time of first emergence of an adult pest insect, where the pest insect develops from an egg through one or more instars. To that end, mechanistic model(s) 150 can include PETE model 335 describing the emergence of the adult stage from the larval or pupal stage immediately preceding it in the developmental trajectory of the insect pest. To model multiple life stages or generations, several PETE models 335 can be coupled in a system. For a system of PETE models 335, an output y(t) from a first generation “g-1” becomes an input I(t) to a second, subsequent generation “g.” In mathematical terms:

$${\text{I}}_{\text{g}} \left(\text{t}\right) = {\text{y}}_{\text{g} - 1} \left(\text{t}\right)$$

A limitation of PETE models 335 is that selecting the values for parameters used in TDD and k can be challenging and represents a significant source of error. Where the mean and variance of emergence time for a population of insects are known, for example, from lab experiments, the Erlang mean and variance equations can be used to determine parameters. In some cases, heuristic-based techniques involve estimating a time to half-emergence of an insect from multiple in situ collections in different host environments over multiple growth seasons of the insect. From the collection data, the time to half-emergence can be used to compute Erlang mean and variances, as the Erlang distribution is symmetrical about a central mean. It is noted, however, that both techniques present significant drawbacks. Using laboratory determined growth parameters can ignore the influence of environmental data 210 other than ambient temperature. Similarly, collection data, based on samples taken from traps, can be labor intensive and produce inconsistent results that are also affected by environmental factors not accounted for in PETE models 335 (e.g., insect activity).

As a further limitation, fitting TDD and k parameters using gradient-descent from in situ trap data is difficult, as “k” is an integer, making the latent microstate equations not differentiable with respect to k. To address this limitation, in some embodiments, a value for “k” can be estimated using coordinate descent to alternately optimize TDD and k, where TDD is updated with standard gradient update with fixed k and k is then selected by exhaustive search on the training loss with fixed TDD.

In some embodiments, example hybrid model 300 implements ML model(s) to generate input data 220 for mechanistic model(s) 150. For example, input data 220 can include values for the DEL function. Advantageously, ML model(s) 145 can learn the nonlinear dependencies of DEL on temperature and other weather and environmental factors. The system of “k” latent microstate equations can then be solved with the predicted value of DEL to obtain predicted population density over time.

In the context of nonlinear dependencies, it is important to distinguish between the population and activity of a pest. Population describes the number of living pests, while activity describes a proportion of the population that is physiologically active in the environment at a given time. Activity may influence measurements of population and can introduce error in training. For example, rain, wind and pesticide use can all reduce the number of flying moths captured in traps but might not impact the actual rate of development. Current sampling methods typically ignore environmental influence on activity, which can be accounted for through training ML model(s) 145 using environmental data 210.

As part of training, predicted population data 240, such as y(t) from PETE model 335, can be compared to observed population data (e.g., ground truth data 170 of FIG. 1) using objective function 325. An example of the objective function can be or include a mean-square error loss function, but other objective functions are contemplated. Backpropagating error through the models 145-150 makes it possible to update the parameters without knowing the true growth rate.

In more detail, example hybrid model 300 can include a learned component implemented as ML model(s) 145. ML model(s) 145 can be or include a fully-connected neural network model 305, a recurrent neural network model 310, a Long-Short Term Memory model 315, a gated recurrent unit model 320, or other model architectures capable of using environmental data 210 to generate input data 220. In an illustrative example, fully connected neural network model 305 can predict a pest growth rate, or the inverse of DEL(t), using environmental data 210 as an input. Mechanistic model(s) 150 implementing PETE model 335 then produce population data 240, such as a population density prediction at a future time.

In the context of fully connected neural network 305, for a series of timepoints, environmental data 210 (e.g. temperature and humidity) can be passed through the neural network for each timepoint individually. From the output of the fully connected neural network 305, temperature-dependent delay can be determined using the DEL equation previously described. By generating input data 220 from environmental data 210 with more than simple temperature information, input data 220 incorporates nuanced information arising from interactions between multiple environmental conditions with pest populations.

In the context of models 310-320 environmental data 210 can be inputted to the ML model(s) 150 as a vector. As such, input data 220 can be or include a vector of time-series values to be used with mechanistic model(s) 150. Models 310-320 can generate input data 220 including a sequence of predicted values (e.g., including a third timepoint temporally after a second time point and a first time point). In this way, population data 240 can include more datapoints for use in fitting population distribution curves (e.g., using the Erlang distribution).

Advantageously, implementing the ML model(s) 145 balances biological knowledge of the role of temperature and the relationship between growth rate and pest emergence with flexibility and sensitivity to latent variables afforded by the learned component. In this way, example hybrid model 300 represents a technical improvement over end-to-end ML approaches by being relatively more stable during training, where an end-to-end ML model uses environmental data 210 as an input to a neural network or other ML model that is trained to generate population data 240 directly. In contrast, by constraining ML model(s) 145 with mechanistic model(s) 150, early predictions of input data 220 and population data 240 can be close to a temperature-only model and are less likely to diverge from a physically meaningful prediction.

More formally, during training, the delay DEL(t) at each timepoint can be described by:

$$\begin{matrix}D E L \left(t\right) = D E {L}_{P E T E} \left(t\right) \times D E {L}_{N N} \left(t\right) \\ = \frac{T D D}{max \left(0 , \left(T \left(t\right) - {T}_{0}\right)\right)} \times {f}_{θ} \left(x \left(t\right)\right)\end{matrix}$$

where ƒ₀ represents ML model 145 and x(t) represents environmental data 210 at time “t.” In some embodiments, DEL(t) is used to solve PETE model 335 above using a Euler solver with timestep dt=0.25 days to obtain the predicted emergence y(t). Training ML model(s) 145 can include applying gradient-based algorithms. In an illustrative example, training can apply the Adam stochastic gradient descent algorithm with mean squared error loss, described by:

$$L \left(y , \hat{y}\right) = \frac{1}{N} {\sum }_{i = 0}^{N} \frac{1}{{K}_{i}} {{\sum }_{k = 0}^{{K}_{i}} \left(y {\left({t}_{k}\right)}^{i} - \hat{y} {\left({t}_{k}\right)}^{i}\right)}^{2}$$

where the first summation is over “N” ground truth 170 samples and the loss is evaluated only at observed timepoints tₖ included as part of training data 130. In some embodiments, the ground-truth 170 samples “y” are normalized to the total number of pests observed in each generation, known from training data 130. Advantageously, normalization improves training by reducing the impact of noise and variability in trap catches on training signal 330.

In some embodiments, ground truth data 170 is collected from various sampling methods used by growers. For example, pheromone traps, egg traps (for flying insects, e.g. Lepidoptera), suction traps (for aphidae) or bucket sampling (for non-flying insects, e.g. Lygus). The inspection rates often vary within a season but for pheromone and egg traps, traps are checked typically at least once per week. Different sampling methods have different degrees of reliability, but typically the data include significant noise. As such, the combination of sparse sampling and high variance introduce significant challenges into preparation of ground truth data 170. For example, a pheromone trap for navel orangeworm captures only adult male moths, relying on an estimate of the proportion of male insects in the overall population to estimate the total population including both male and female insects.

Generating training data 130 can include receiving environmental data 210 describing the environment for multiple time points over a period of time and receiving pest population data describing the population of the pest in the environment for at least a subset of the time points (e.g., ground truth data 170). The subset, in this instance, refers to the possibility that ground truth data 170 from insect trap catches can be collected less frequently than environmental data, such that labeled training data 130 may be limited to those environmental datapoints that correspond to a population datapoint.

During training, parameters of mechanistic model 150 can be tuned in addition to learned parameters of ML model(s) 145. For example, PETE model 335 parameters (TDD and k) can be modified based on training signal 330 without modifying learned parameters of ML model(s) 145. After mechanistic model 150 has converged or is within an allowable error margin, ML model(s) 145 can then be trained using tuned mechanistic model 150. Tuning mechanistic model(s) 150 can also include tuning an integer value for “k.” In some embodiments, “k” is constrained to a number less than 100, less than 90, less than 80, less than 70, less than 60, less than 50, less than 40, less than 30, less than 20, less than 10, less than 9, less than 8, less than 7, less than 6, less than 5, less than 4, less than 3, or less than 2, including interpolations thereof. Constraints on the size of k can be guided by biological information about a given pest. Advantageously, constraining “k” to a biologically meaningful number permits mechanistic model(s) 150 to be tuned while also reducing the computational demand of fitting a model to training data 130.

In some cases, training data can include more than one generation in a single datapoint, as, for example, when in situ trap collection does not distinguish between different pest generations. As such, example hybrid model 300 can include multiple mechanistic models 150 corresponding to multiple generations, each generation represented by one or more PETE models 335 corresponding to individual developmental stages. The number of generations to be modeled can be pre-defined based at least in part on pest/host biology and data collection period. In an illustrative example, an almond orchard can typically host about three generations of navel orangeworm in a single growing season. In this way, example hybrid model 300 can describe 1 or more generations, 2 or more generations, 3 or more generations, 4 or more generations, 5 or more generations, 6 or more generations, 7 or more generations, 8 or more generations, 9 or more generations, 10 or more generations, or more, depending on environmental conditions and the physiological behavior of the pest. For example, aphids tend to exhibit faster generation times than insects that pupate.

In some embodiments, however, training of example hybrid model 300 includes fitting a number of mechanistic models 150 to the training data 130. For example, an initial prediction of the number of generations can be generated by clustering ground truth data 340 to classify different generations. In another example, a predicted shape of the Erlang distribution can be used to fit multiple population distribution curves to ground truth data 340, using an error minimization algorithm. It is contemplated that a combination of such training approaches can be used, for example, by selecting initial values for “k” and for the number of generations based on pest/host biology.

FIG. 4 is a schematic diagram illustrating example environmental data 210, in accordance with embodiments the disclosure. Environmental data 210 includes spatial data 405 and temporal data 410, allowing environmental data 210 to describe the state of a host environment in one or more spatial dimensions and in time. Environmental data 210, as described in more detail in reference to FIGS. 1-3, can include data from multiple different sources, including temperature data 415, wind data 420, humidity data 425, land-use data 430, or the like.

Environmental data 210 can include temporal data 410 mapped to a geographic location of the host environment through spatial data 405. In some embodiments, environmental data includes values for temperature 415, wind 420, humidity, and land-use 430, but also can include precipitation, smoke, atmospheric pressure, or the like. In this way, hybrid models can leverage the strengths of ML model(s) 145 to model covariance between different spatial predictions at a given timepoint. Advantageously, such an approach can permit hybrid models to represent true spatiotemporal models that account for the influence of environmental conditions on population data 240 both spatially and temporally. In some embodiments, environmental data 210 include environmental data for multiple physical locations, of which models 145-150 generate population data for a subset of the physical locations. For example, a precipitation map can include data at a resolution higher than the models 145-150 can predict, based at least in part on limited resolution of other environmental data 210 or ground truth 170 data. In this way, input data 220 and/or population data 240 can be generated at a lower spatial resolution than environmental data 210.

Each data type can be expressed as a probability (e.g., a fraction or percentage), as a coded value, as a numerical value, or in other forms as may be received from the source(s) of environmental data 210. Each environmental data point can be associated with a timepoint and geographical coordinates, for example, through a GPS reference. As such, environmental data 210 can describe a multi-modal dataset in space and time for the host environment. In some embodiments, environmental data 210 is represented numerically by a tuple including a timepoint, spatial coordinates, and a value for each environmental data type being measured (e.g., an n-tuple where n is the number of entries in the datum). Collectively, multiple tuples can form a time-sequence that can be used as an input for RNN, LSTM, and/or GRU models. Individually, each tuple can serve as an input to hybrid models using fully connected neural networks.

With respect to land-use 430 data, it is understood that some vegetation and/or land conditions can serve as direct hosts of pest organisms, some can serve as reservoirs of pest organisms, and some can serve as attractants or repellants for pest organisms. For example, wild land abutting a cultivated plot can serve as a reservoir of pest insects, where the wild land is not managed to limit the population of the pest. Similarly, crop rotation and other agricultural techniques can leave land fallow near a host environment, which can serve as a source of pest population. Land-use 430 data can encode one or more uses of land in the geographic area in and around the host environment. For example, land-use can be expressed numerically as a binary Boolean value, where true indicates host land and false indicates non-host land. In another example, land-use can be expressed numerically as an integer value, with each integer value corresponding to a different use. In some embodiments, land-use is classified from images by trained ML models, such that land-use can be expressed numerically as a probability that a given geographical position corresponds to cultivated land. A probability value can provide a continuous and differentiable input to ML Model(s) 145, which may simplify training.

FIG. 5A is an example population graph 500 illustrating example data generated by a hybrid model trained to predict and/or model population density distribution as a function of time, in accordance with embodiments of the disclosure. Example population graph 500 includes a fitted population density curve 505, ground truth data 510, and predicted population data 515 for a single pest generation. In example population graph 500, the ordinate represents growing degree days (GDD), in units of Temperature-Time (e.g., °C-Days), and the abscissa represents population density in arbitrary units. It is understood that the data presented in example population graph 500 are illustrative and do not represent an actual pest-host system or real output data from example system 100. Instead, FIG. 5A is intended to illustrate data that can be generated by embodiments described in reference to FIGS. 1-4.

Data represented on example population graph 500 illustrates that sparse ground truth data 510 can be used to train a model to generate predicted population data 515 for a pest population, from which useful information can be derived. Fitting an Erlang distribution, for which the number of latent microstates “k” is fitted, can permit a peak emergence value 520 to be estimated (e.g., by finding the mid-point value or by finding a stationary point). Additionally, integration of fitted population density curve 505 can generate an estimated total emergence. Similarly, from fitted population density curve 505, an intervention window 525 can be generated that describes a period of time within which an intervention against the pest is likely to be effective. Intervention window 525 can also incorporate information about the host environment. For example, where a host plant bears flowers or fruit that is sensitive to chemical interventions, intervention window(s) 525 for such interventions can be constrained by an estimated timing for the onset of flowering and/or fruiting of the host plants.

While intervention window 525 is shown preceding the peak value 520 in terms of GDDs, intervention window 525 can be broader or narrower where indicated by information specific to the intervention type. To that end, example system 100 of FIG. 1 can store metainformation describing interventions in terms of timing, durations, and counter-indicated events. Such metainformation can be used to constrain intervention window 525. In an illustrative example, a pesticide spraying intervention can be indicated from first emergence of a pest until the host-plant flowers, to avoid killing pollinating insects. As such, first emergence can be determined from the fitted population density curve 505 and the timing of flowering from agricultural information about the host. Together, the two events define the respective temporal bounds of intervention window 525 in this example.

FIG. 5B is an example cumulative population graph 530 illustrating example data generated by a hybrid model trained to predict and/or model cumulative population density as a function of time, in accordance with embodiments of the disclosure. The data presented in example graph 530 illustrates an approach to fitting a cumulative emergence curve 535 as a function of accumulated growing degree days (GDDs). The cumulative emergence fraction describes a proportion of the total population of a pest 540 (e.g., in all life stages) that is in a particular life stage or generation that has emerged up to a given time. In example graph 530, the ordinate represents growing degree days (GDD), in units of Temperature-Time (e.g., °C-Days), and the abscissa represents population density in arbitrary units. It is understood that the data presented in example graph 530 is illustrative and does not represent an actual pest-host system or real output data from example system 100. Instead, FIG. 5B is intended to illustrate data that can be generated by models as described in reference to FIG. 1-5A.

Modelling cumulative emergence fraction can include fitting cumulative emergence as a function of GDD to a logistic sigmoid model. Cumulative emergence is estimated from the expression for the fraction of total population:

$${p}_{i} = \frac{{c}_{i}}{\sum {}_{j = 0}^{N} {c}_{j}}$$

where pi represents the fractional population at timepoint “i,” cᵢ represents the population at timepoint “i,” cⱼ represents population at a timepoint in the population data set for the generation, and “N” represents the number of timepoints in the population.

The cumulative emergence at timepoint i is then computed as the cumulative sum of the emerged proportions up to time i, expressed as:

$${F}_{i} = {\sum }_{j = 0}^{i} {p}_{j} f o r i = 1 , … , N$$

Predicted cumulative emergence curve 535 is expressed using the logistic sigmoid transformation, fitted to ground truth 170 and population data 240 using least squares regression techniques:

$${\hat{F}}_{i} = \frac{1}{1 + exp \left(- \left({β}_{0} + {β}_{1} {x}_{i}\right)\right)}$$

where {β₀, β₁} represent model fitting parameters and x denotes the accumulated degree days (GDDs) up to time i.

The model can be fitted by minimizing the mean square error (MSE) between the predictions

$$\left({\hat{F}}_{i}\right)$$

(ᵢ) and observed (Fᵢ) cumulative emergence:

$${β}^{*} = arg m i n {\sum }_{i = 1}^{M} {\sum }_{j = 1}^{N} {\left({\hat{F}}_{j}^{i} - {F}_{j}^{i}\right)}^{2}$$

which can be solved using gradient descent or any other non-linear least squares approach. While the model looks similar to logistic regression, the outcome variable is continuous and not binary.

The predicted cumulative emergence curve can be transformed into a population density (instantaneous emergence) curve by differentiating with respect to time (GDDs):

$$f = \frac{d \hat{F}}{d x} = \hat{F} \left(1 - \hat{F}\right)$$

Various event predictions can also be obtained from the predicted cumulative emergence. In general, predicted time x* (in GDDs) of a given fraction of emergence F̅^{∗} can be computed using the expression:

$$\hat{F} * = \frac{1}{1 + exp \left(- \left({β}_{0} + {β}_{1} {x}_{i}\right)\right)} ⇒ {x}^{*} = \frac{- \frac{1 - {\hat{F}}^{*}}{{\hat{F}}^{*}} - {β}_{0}}{{β}_{1}}$$

For example, a time of first emergence can be determined by defining a threshold predicted cumulative emergence fraction 545 (e.g., F̅^{∗} = 0.03 or 3%). Similarly, a time of half emergence (e. g., ^{∗} = 0.50) can be predicted by determining the time in GDDs at which F̅ is equal to one half. As the logistic distribution is symmetrical about a mean value, the time of half emergence corresponds to peak emergence 520. Finally, full emergence 540 (e.g., F̅^{∗} = 0.995) can be used to distinguish between generations. For example, a hybrid model can include multiple instances of ML model(s) 145 and/or mechanistic model(s) 150, with instances fitted for each generation.

As previously described, multi-generational mechanistic models 150 can include multiple mechanistic models 150 connected in series, such that an input population I(t) is received from the output population y(t) of a preceding model 150. The number of generations within a given period of time, such as a growing season, calendar year, or the like, can be pre-determined, for example, based on biological characteristics of pest/host systems.

FIG. 5C is an example contour graph 550 illustrating example data generated by a hybrid model trained to predict and/or model population density distributions as a function of time and space, in accordance with embodiments of the disclosure. Example contour graph 550 includes population data 240 visualized as a set of contour lines 555 projected onto environmental data 210 including land-use 430 data. As illustrated, example contour graph 550 can be presented as a two-dimensional image or image sequence (e.g., as a time-sequence) to visualize the geographic extent of predicted pest infestation and/or the predicted temporal development of pest emergence or migration.

Advantageously, ground truth data 170 developed from trap catches or other collection methods can be used to inform the spatial and temporal predictions of hybrid models at least in part during training of ML model(s) 145. Additionally, presenting locations of labeled data 510 as part of population predictions can improve user interpretation of predicted data as part of an interactive pest management platform. In some embodiments, a series of instances of example contour graph 550 are generated using time-sequence data for contour lines 555 that can be used as frames in a motion picture file. Encoded for presentation on an electronic display, such motion picture files can be outputted as part of the operation of example system 100 of FIG. 1, such as in operation 209 of example process 200 of FIG. 2.

In some embodiments, land-use data 430 can be used to identify intervention region(s) 560. In contrast to intervention window(s) 525, described in more detail in reference to FIGS. 5A-5B, an intervention region 560 describes a spatial extent within which a particular intervention is to be applied. Intervention region 560 can be determined by classifying crop land into vegetation that is susceptible to pest infestation, as opposed to land that is pest resistant. In this way, application of chemical pesticides or other interventions can be restricted to regions where such intervention will be effective. Similarly, intervention region(s) 560 can be limited to those areas where a user has legal control or where pesticide use is permitted. For example, land ownership can be encoded into land-use data 430, conservation easements can be applied to limit intervention, and whether a crop is organic or allows pesticide can be incorporated into determining intervention region(s) 560. Advantageously, spatial or geographic constraints on intervention can reduce pesticide use by improving targeted intervention in both time and space.

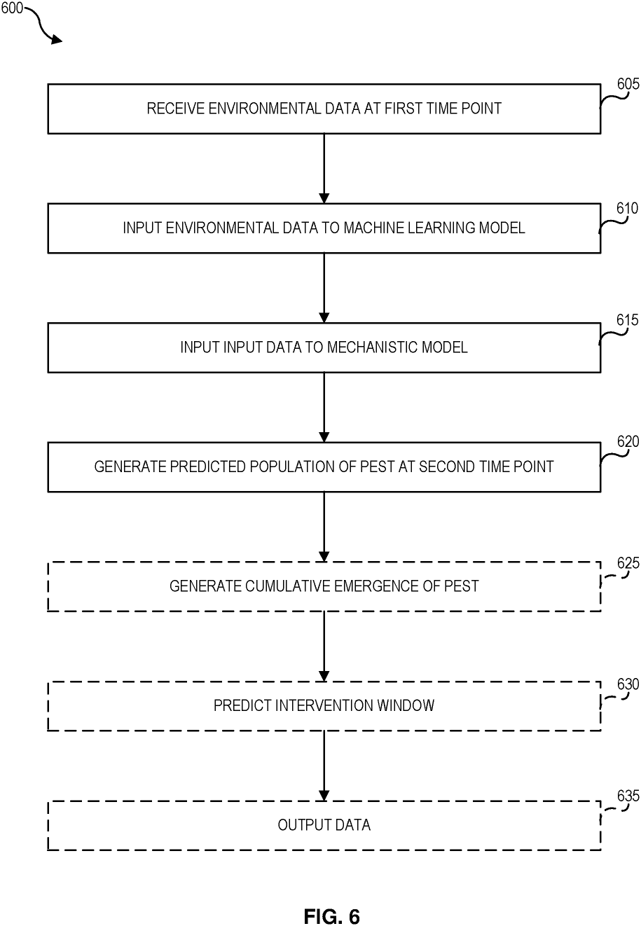

FIG. 6 is a block flow diagram illustrating an example method 600 for modelling population dynamics of a pest, in accordance with embodiments of the disclosure. Example process 600 describes an example of operations implemented by a computer system (e.g., server(s) 105 of FIG. 1) as part of deploying trained model(s) 145, as described in more detail in reference to example process 200 of FIG. 2. The order in which some or all of the process blocks appear in process 600 should not be deemed limiting. Rather, one of ordinary skill in the art having the benefit of the present disclosure will understand that some of the process blocks can be executed in a variety of orders not illustrated or in parallel and can be repeated, omitted, or assigned to other systems.

At block 605, the computer system receives environmental data 210 for a first time point. As described in more detail in reference to FIGS. 1-4, environmental data 210 can be or include measured and/or predicted data describing a host environment for a pest/host system. Environmental data 210 can be received from one or more sources including weather systems (e.g., weather forecast data), in situ sensors (e.g., meteorological sensor stations), internet connected sensor-bearing devices (e.g., agricultural vehicles, mobile electronic devices, etc.), by manual entry by human users. In some embodiments, data are received separately from multiple sources, such that the computer system, as part of operations at block 605, synthesizes environmental data 210 from the disparate source data. For example, each data source can be configured for a different sampling period, such that preparation operations can include sub-sampling at least some of the source data such that each entry of environmental data 210 includes a complete set of environmental measurements for each timepoint.

At block 610, the computer system inputs environmental data 210 to ML model(s) 145. In some embodiments, ML model(s) 145 are trained to generate input data 220 for mechanistic model(s) 150 at a second time point, temporally after the first time point, from the environmental data 210 for the first time point. In this context, the first time point can refer to present-time or otherwise current data, but can also refer to a future time where environmental data 210 describes predicted conditions of the host environment. As described in more detail in reference to FIGS. 1-3, input data 220 generally refers to an input parameter for a mechanistic model 150 that would otherwise ignore the influence of environmental factors on population in favor of applying simplifying assumptions. Advantageously, ML model(s) 145 can be trained to generate the input parameters called for by mechanistic model(s) 150 while also learning complex interactions between multiple environmental conditions in time and space. In some embodiments, ML model(s) 145 include recurrent neural networks, such as vanilla RNN models, LSTM models, GRU models, or the like. With such models, input data 220 can include a sequence of input parameters for mechanistic model(s) 150. For example, an input to ML model(s) 145 including environmental data 210 for a first time point can be used to generate input data 220 including parameters for a second timepoint and a third timepoint, temporally after the second time point.

At blocks 615-620, the computer system inputs input data 220 to mechanistic model(s) 150 and mechanistic model(s) 150 generate predicted population data 240 at a second time point. In this context, “second time point” refers to a time temporally after the first time point. As such, the first time point and the second time point are separated by a time step. In some embodiments, the time step is a fraction of a growing degree day, such as about 0.05 GDDs, about 0.1 GDDs, about 0.15 GDDs, about 0.2 GDDs, about 0.25 GDDs, about 0.3 GDDs, about 0.35 GDDs, about 0.4 GDDs, about 0.45 GDDs, about 0.5 GDDs, about 0.55 GDDs, about 0.6 GDDs, about 0.65 GDDs, about 0.7 GDDs, about 0.75 GDDs, about 0.8 GDDs, about 0.85 GDDs, about 0.9 GDDs, about 0.95 GDDs, including fractions and interpolations thereof, but may also correspond to periods of time exceeding one GDD.

In some embodiments, mechanistic model(s) 150 include one or more PETE models that have been tuned to predict populations of a particular pest at a given life stage. For example, where a pest causes significant damage to the host in a larval stage, intervention can be based on larval population, rather than adult population. In another example, the population of the adult insect can be used where an intervention is particularly effective or available for adults but not for larvae. To that end, input data 220 can include an input population of eggs in the host environment and input parameters, such as a DEL parameter, and mechanistic model(s) can include “k” latent microstates corresponding to the number of intermediate micro-states between the egg stage for which data is available and the larval stage to be modeled.

In some embodiments, the computer system includes generating cumulative emergence of the pest as part of population data 240, at block 625. As described in more detail in reference to FIGS. 1-3 and FIG. 5B, cumulative emergence describes a fraction of the estimated total emergence of the pest for a given generation. Cumulative emergence, which can be modeled using logistic sigmoid function 230 fitted to cumulative population density data, can be used to predict timings and intervention windows, as well as to determine when a given generation has ended and the next has begun. As described in more detail in reference to FIG. 5B, a timing for first emergence can be estimated by comparing the cumulative emergence at a predicted future time (e.g., the “second time point”) to a threshold parameter that defines the first emergence, such as 1% of total emergence, 2% of total emergence, 3% of total emergence, 4% of total emergence, 5% of total emergence, 6% of total emergence, 7% of total emergence, 8% of total emergence, 9% of total emergence, 10% of total emergence, or more, including fractions and interpolations thereof. It is understood that the value of the threshold parameter can be defined from biological information about the pest, as well as information about the temporal sensitivity of the intervention.

In some embodiments, the computer system can generate intervention timings and/or windows, at block 630. With timings determined from cumulative emergence data, intervention windows (e.g., intervention window 525 of FIG. 5A) and other event timings can be derived for use in recommending and/or implementing intervention strategies against the pest. For example, with a first emergence indicated by the second time point, the intervention window can overlap the second time point. In an illustrative example, environmental data 210 for a first time point are used to predict population data at a second time point corresponding to one day after the first time point. The population data for the second time point indicates that the first emergence of the pest will occur in the host environment around the second time point. The computer system can, therefore, define an intervention window that begins on or before the second time point, and ends after the second time point.

In some embodiments, the computer system can output population data 240 or other data (e.g., input data 220, environmental data 210) at block 635. Outputting operations, as described in more detail in reference to FIG. 2, can include storing data, including population data 240, input data 220, environmental data 210, and intervention timing data, on one or more storage systems. Outputting operations can also include communicating data to associated systems, as through notifications and audiovisual information for presentation to a user. Additionally or alternatively, outputting operations can include implementing interventions directly, as when example system 100 includes automated (e.g., without human involvement) or semi-automated (e.g., with human oversight or control) intervention systems, such as sprayer systems or automated deployment systems, as when an unmanned aerial vehicle deploys pest parasite organisms to control pest populations (e.g, persimilis to attack spider mites).

The processes explained above are described in terms of computer software and hardware. The techniques described can constitute machine-executable instructions embodied within a tangible or non-transitory machine (e.g., computer) readable storage medium, that when executed by a machine will cause the machine to perform the operations described. Additionally, the processes can be embodied within hardware, such as an application specific integrated circuit (“ASIC”) or otherwise.

A tangible machine-readable storage medium includes any mechanism that provides (i.e., stores) information in a non-transitory form accessible by a machine (e.g., a computer, network device, personal digital assistant, manufacturing tool, any device with a set of one or more processors, etc.). For example, a machine-readable storage medium includes recordable/non-recordable media (e.g., read only memory (ROM), random access memory (RAM), magnetic disk storage media, optical storage media, flash memory devices, etc.).

The above description of illustrated embodiments of the invention, including what is described in the Abstract, is not intended to be exhaustive or to limit the invention to the precise forms disclosed. While specific embodiments of, and examples for, the invention are described herein for illustrative purposes, various modifications are possible within the scope of the invention, as those skilled in the relevant art will recognize.

These modifications can be made to the invention in light of the above detailed description. The terms used in the following claims should not be construed to limit the invention to the specific embodiments disclosed in the specification. Rather, the scope of the invention is to be determined entirely by the following claims, which are to be construed in accordance with established doctrines of claim interpretation.

What is claimed is:

1. A computer implemented method for modeling a population density of a pest, the method comprising:
receiving environmental data corresponding to a first time point;
generating model input data from the environmental data using a machine learning model; and
generating a population density of the pest from the model input data using a mechanistic model, wherein the population density corresponds to a second time point temporally after the first time point.

2. The computer implemented model of claim 1, further comprising:
generating an estimated total emergence of the pest value using the population density of the pest at the second time point;
generating an estimated cumulative emergence of the pest at the second time point using the population density of the pest at the second time point, wherein the estimated cumulative emergence describes a fraction of the total emergence of the pest; and
predicting an intervention window using the cumulative emergence, wherein the intervention window corresponds to a period of time during which an intervention is recommended to prevent proliferation of the pest.

3. The computer implemented method of claim 2, wherein predicting the intervention window comprises:
comparing the cumulative emergence to a pre-determined threshold value for a first emergence of the pest; and
in response to the cumulative emergence at the second time point meeting or exceeding the threshold value, predicting the intervention window to overlap the second time point.

4. The computer implemented method of claim 2, wherein predicting the intervention window comprises:
generating a predicted time of a pre-determined threshold emergence fraction using a logistic sigmoid model, wherein the threshold emergence fraction corresponds to a fraction of the total emergence of the pest at which an intervention is indicated; and
selecting the intervention window to overlap the predicted time.

5. The computer implemented model of claim 1, wherein the environmental data comprise environmental data for a plurality of physical locations and wherein the population density comprises population data for at least a subset of the plurality of physical locations.

6. The computer implemented model of claim 1, wherein the machine learning model is a fully connected neural network model.

7. The computer implemented model of claim 1, wherein the machine learning model is a recurrent neural network model, and wherein the model input data further describes a third time point temporally after the second time point.

8. The computer implemented model of claim 1, wherein the mechanistic model comprises a Predictive Extension Timing Estimator (PETE) model, and wherein the model input data comprises a delay parameter (DEL).

9. The computer implemented model of claim 1, wherein the environmental data comprise one or more of temperature data, atmospheric pressure data, relative humidity data, precipitation data, or land-use data.

10. The computer implemented method of claim 1, further comprising training the machine learning model by:
receiving training data comprising a population of the pest and a corresponding environmental parameter;
generating a training input for the environmental parameter using the machine learning model;
generating a training population density using the mechanistic model and the training input;
comparing the training population density to the population of the pest;
generating a training signal using the comparison; and
modifying a parameter of the machine learning model using the training signal.

11. The computer implemented method of claim 9, wherein receiving training data comprises:
receiving environmental data describing the environment for a plurality of time points over a period of time preceding the first time point;
receiving pest population data describing the population of the pest in the environment for at least a subset of the plurality of time points; and
generating a training tuple comprising environmental data and pest population data for a time point of the subset of the plurality of time points.

12. The computer implemented method of claim 1, further comprising outputting the population density to a client computing device.

13. At least one machine-accessible storage medium that provides instructions that, when executed by a machine, will cause the machine to perform operations comprising:
receiving environmental data corresponding to a first time point;
generating model input data from the environmental data using a machine learning model; and
generating a population density of a pest from the model input data using a mechanistic model, wherein the population density corresponds to a second time point temporally after the first time point.

14. The at least one machine-accessible storage medium of claim 13, wherein the instructions, when executed by the machine, further cause the machine to perform operations comprising:
generating an estimated total emergence of the pest value using the population density of the pest at the second time point;
generating an estimated cumulative emergence of the pest at the second time point using the population density of the pest at the second time point, wherein the estimated cumulative emergence describes a fraction of the total emergence of the pest; and
predicting an intervention window using the estimated cumulative emergence, wherein the intervention window corresponds to a period of time during which an intervention is recommended to prevent proliferation of the pest.

15. The at least one machine-accessible storage medium of claim 14, wherein predicting the intervention window comprises:
comparing the cumulative emergence to a pre-determined threshold value for a first emergence of the pest; and
in response to the cumulative emergence at the second timepoint exceeding the threshold value, predicting the intervention window to overlap the second time point.

16. The at least one machine-accessible storage medium of claim 14, wherein predicting the intervention window comprises:
generating a predicted time of a pre-determined threshold emergence fraction using a logistic sigmoid model, wherein the threshold emergence fraction corresponds to a fraction of the total emergence of the pest above which an intervention is ineffective at reducing a proliferation of the pest; and
selecting the intervention window to overlap the predicted time.

17. The at least one machine-accessible storage medium of claim 13, wherein the environmental data comprise environmental data for a plurality of physical locations and wherein the population density comprises population data for at least a subset of the plurality of physical locations.

18. The at least one machine-accessible storage medium of claim 13, wherein the machine learning model is a fully connected neural network model.

19. The at least one machine-accessible storage medium of claim 13, wherein the machine learning model is a recurrent neural network model, and wherein the model input data further describes a third time point temporally after the second time point.

20. The at least one machine-accessible storage medium of claim 13, wherein the mechanistic model comprises a Predictive Extension Timing Estimator (PETE) model, and wherein the model input data comprises a delay parameter (DEL).

21. The at least one machine-accessible storage medium of claim 13, wherein the instructions, when executed by the machine, furth cause the machine to perform operations comprising:
generating visualization data describing the population density; and
presenting the visualization data using a display.
